(19) United States
(12) Patent Application Publication
(10) Pub. No.: US 2014/0106096 A1
(43) Pub. Date: Apr. 17, 2014

(54) Packaging

(71) Applicant: APPLE INC., Cupertino, CA (US)

(72) Inventors: Mark E. DOUTT, San Jose, CA (US); Paul CHOINIERE, Livermore, CA (US); Paul E. NEWBURN, San Jose, CA (US)

(73) Assignee: Apple Inc., Cupertino, CA (US)

(21) Appl. No.: 13/649,793

(22) Filed: Oct. 11, 2012

(51) Int. Cl. B32B 27/18; B32B 1/02; C08L 23/12; B32B 27/32

(52) U.S. Cl. 428/35.2; 428/516; 428/212; 428/447; 524/582

(57) ABSTRACT

A packaging film including one or more layers of biaxially oriented polypropylene film and an antiblocking agent. The type and amount of antiblocking agent can be tailored such that the film does not visibly scratch an item in contact with the film during normal distribution and handling. For example, the film can be tailored to reduce or eliminate scratches on a polycarbonate polymer surface. In some embodiments, the film is clear and transparent and has a crinkly texture. One or both sides of the film can also be heat sealable. Additional additives or surface treatments can be used to achieve desired effects.

### BACKGROUND

1. Field

Embodiments of the present invention relate to packaging films and bags formed by packaging films.

2. Background

Items are often enclosed in packaging for distribution and handling. Packaging can, for example, be designed to provide physical protection of the item, aesthetic appeal to the consumer, and convenience during distribution and handling.

Plastic films are often used in packaging. For example, sheets of film or bags formed from one or more sheets of film can be used to contain or protect items. The film can also be contained within other packaging, such as a box or clamshell container, which can provide additional protection or containment of an item. For items having a heightened susceptibility to scratches, such as certain polycarbonate surfaces, it can be especially desirable to develop packaging film that does not visibly scratch the item during normal distribution and handling. In some cases, it can be desirable for such packaging film to also exhibit other characteristics, such as a desired texture, color, or other mechanical or material properties.

### BRIEF SUMMARY

In broad terms, a packaging film can include one or more layers of film, such as bi-axially oriented polypropylene (BOPP) film having one or more additives, such as certain antiblocking additives. The type and amount of additives used in the film can be selected such that the film does not visibly scratch the surface of an item in contact with the film during normal distribution and handling. For example, the film can be tailored to reduce or eliminate scratches on a polycarbonate polymer surface, such as those found on certain computer accessories. In some embodiments, the film is clear and transparent. In some embodiments, the film is thin and rigid, which can result in the film having a crinkly feel. One or both sides of the film can also be heat sealable which can, for example, allow the film to form an enclosure. Additional additives or treatments can be used to realize other desired effects or properties.

Additional features of the invention will be set forth in the description that follows, and in part will be apparent from the description, or may be learned by practice of the invention. Both the foregoing general description and the following detailed description are exemplary and explanatory and are intended to provide further explanation of the invention.

### BRIEF DESCRIPTION OF THE FIGURES

The accompanying figures, which are incorporated herein, form part of the specification and illustrate exemplary embodiments of the present invention. Together with the description, the figures further serve to explain the principles of, and to enable a person skilled in the relevant art(s) to make and use the exemplary embodiments described herein.

FIG. 1 illustrates a piece of film in accordance with an embodiment of the present invention.

FIG. 2 illustrates a bag in accordance with an embodiment of the present invention.

FIG. 3 illustrates a bag in accordance with an embodiment of the present invention containing an exemplary computer mouse.

FIG. 4 is a diagram of a simplified cross-section of a one-layer piece of film.

FIG. 5 is a diagram of a simplified cross-section of a three-layer piece of film.

FIG. 6 is a diagram of a simplified cross-section of another three-layer piece of film.

FIG. 7 is a diagram of a simplified cross-section of another three-layer piece of film.

FIG. 8 is a diagram of a simplified cross-section of another three-layer piece of film.

FIG. 9 is a diagram of a simplified cross-section of a four-layer piece of film.

FIG. 10 is a diagram of a simplified cross-section of a five-layer piece of film.

### DETAILED DESCRIPTION

The following detailed description refers to the accompanying figures, which illustrate exemplary embodiments of the present invention. Other embodiments are possible. Modifications may be made to the exemplary embodiments described herein without departing from the spirit and scope of the present invention. Therefore, the following detailed description is not meant to be limiting. The operation and behavior of the embodiments presented are described with the understanding that modifications and variations may be within the scope of the present invention.

Some existing packaging films can undesirably scratch the surface of items in contact with the film. Scratches can occur, for example, during transportation or handling of the packaging. The material of the film is one factor that can affect the amount of scratching caused by the film. For example, some polypropylene (PP) films with embedded hard particles such as certain silica additives can cause scratches on soft surfaces. The particles can cause scratches due to the creation of high and low points on the film's surface. In some cases, particles protruding from a first side of the film can scratch adjacent opposite sides of the film while the film is being wound or unwound.

In addition, scratched surfaces of a film can potentially act as stress points or abrasive points. That is, even if there are no hard particles in or on the film, the previously scratched surface of the film can itself cause scratches. In some films, scratches can be caused by the film itself even if it does not contain embedded particles. As a result, attempting to remove all particles from such a film may not entirely eliminate scratches. For at least the above reasons, it can be desirable to develop a film that does not visibly scratch an item in contact with the film during normal distribution and handling. In some cases, it can be desirable for such packaging to also exhibit other characteristics, such as a desired texture, color, or other mechanical or material properties.

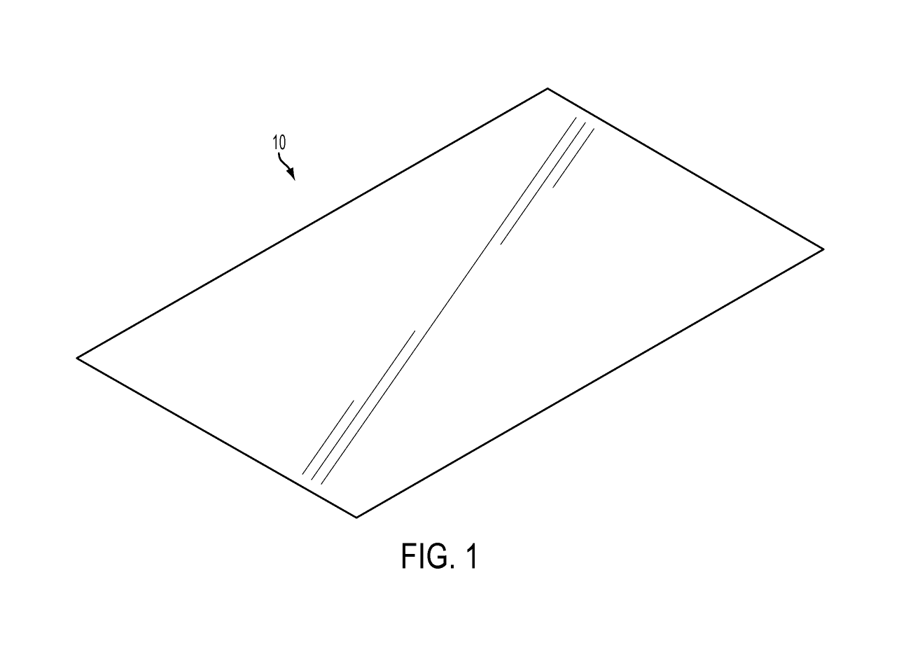

FIG. 1 illustrates a piece of transparent film shown generally at 10 in accordance with an embodiment. Film 10 can be used to form a packaging bag that can be used to protect items from being scratched during distribution and handling. In some embodiments, the bag can be configured to contain one or more items made of polycarbonate or having one or more polycarbonate surfaces. Such items can include, for example, electronic devices, computer accessories, or electronic components. In particular, the bag can be configured to contain one or more computer mouses, keyboards, tablet computers, media players, and/or phones.

As described further herein, the properties of base polypropylene can be tailored by mixing the base polypropylene with certain additives. The additives can be mixed with the base polypropylene using one or more conventional thermoplastic processes, such as for example during compounding in an extruder or dry blending at a feed hopper during sheet extrusion. Film can then be created by extrusion to produce a cast sheet of film having a desired shape and thickness. The extrusion process can be continuous, which can produce an indefinitely long material, or it can be semi-continuous, which can produce multiple discrete extrusions. The extrusion process can include the use of heated or non-heated stock material.

The cast sheet of film can then be converted to bi-axially oriented polypropylene (BOPP) film to increase its strength and clarity. The conversion process includes extruding the cast sheet of film and then stretching it in both the machine direction and an across-machine direction. Film 10 can, for example, be produced in large rolls which can then be slit on slitting machines into smaller rolls for use on packaging machines. Trade names for BOPP and other films include MOPLEN™ (e.g., MOPLEN™ HP522H, which is also known as LyondellBasell HP 522 H by LyondellBasell Industries of Rotterdam, Netherlands), DOWLEX™ SC 2108G Polyethylene Resin (by The Dow Chemical Company of Midland, Mich.), and NAN YA 2020S (YUNGSOX 2020S) (by Formosa Plastics Corporation of Taiwan, R.O.C.).

MOPLEN™, for example, is a polypropylene homopolymer without slip additives or antiblocking additives. With respect to its material properties, MOPLEN™ is a semi-crystalline and stiff polymer having a melt flow rate (MFR) of approximately 10 g/10 min (230° C./2.16 Kg) and a tensile modulus of approximately 1500 MPa (1 mm/min). After biaxial orientation, MOPLEN™'s tensile modulus increases to about 1700-2000 MPa in machine direction and about 2800-3800 MPa in transverse direction.

In some embodiments, the thickness of film 10 can range from about 20 microns (0.78 mils) to about 250 microns (9.84 mils). Suitable uses for films having a thickness of approximately 1 mil can include, for example, dust protection, grocery store produce bags, and packaging for small parts and items having an irregular shape. Suitable uses for films having a thickness of approximately 1.5 mil to approximately 2 mil can include, for example, moisture protection, plastic sandwich bags, and packaging for certain clothing or food items, such as nuts or candy. Suitable uses for films having a thickness of approximately 3 mil can include packaging for items requiring added strength, such as tools, hardware, metal fasteners, and furniture. Suitable uses for films having a thickness of approximately 4 mil can include, for example, packaging for items such as gears, bolts, auto parts, and heavy items with sharp corners. Suitable uses for films having thicknesses of above approximately 4 mil can include, for example, extra heavy duty packaging applications. In some embodiments, film 10 has a varying thickness.

Film 10 can include additives that affect the material and mechanical properties of the film. The amount of additives used in the film can depend, for example, on the desired film thickness, the presence of other additives within the film, and desired subsequent film treatments. In some embodiments, film 10 can include multiples additives having different sizes in shapes. In some embodiments, the additives are substantially spherical.

Film 10 can include certain antiblocking additives that can, for example, facilitate winding and unwinding of a roll of film by creating a spacing effect that allows air flow between layers of film. Once compounded into a plastic, antiblocking additives can create a microrough surface that reduces adhesion between film layers thereby lowering blocking tendency between the layers. The antiblocking additives can also affect the Coefficient of Friction (COF) of the film. This can, for example, allow for smooth transport of the film web over rollers during converting and bag making operations.

Two factors that can determine the effect of an antiblocking additive are the number of particles of antiblock at the film surface and the size of the antiblock particles, in general, the greater the concentration of antiblock particles within the film, the rougher the film surface produced. In some embodiments, the antiblocking particles on the layer of film facing the inside of the bag are spherical. Such spherical particles can serve to minimize scratches during roll winding operations. In some embodiments, antiblocking particles can be lubricated with silicone oil or silicone gum which can reduce scratches formed by the film. Examples of antiblock additives include synthetic silica, limestone, natural silica, talc, zeolites, organic additives, such as certain hard waxes and fatty acid amides. Trade names for certain antiblock additives include: CONSTAB™ AB 06064 PPR (by CONSTAB™ Polyolefin Additives GmbH of Rüthen, Germany), CONSTAB™ SAB 06564 (antiblock and slip), and Shantou Best Polybatch ABPP905A (by Guangdong Meilian New Materials Technology Co., Ltd, of Shantou China, formerly known as Shantou Meilian Chemical Co., Ltd.).

In some embodiments, certain migratory slip and antistatic additives can be included that can provide a lubrication layer on the surface of the film. Such migratory additives can bloom to the surface of the film to create a lubricating layer between the surface of the film and the surface of the item. Slip additives can be used to reduce the surface coefficient of friction of the film, which can substantially prevent the film from sticking to itself and other surfaces such as converting equipment. Antistatic additives can be used to resist dust and dirt on the surface of the film by migrating to the surface of the film to dissipate static charge. Slip and antiblock additives can be used together to provide a desired balance between slip and antiblock performance. One or more of the migratory additives described herein can have a controlled solubility, which can provide a reservoir of material that continuously migrates to the surface. Trade names for certain slip and antistat additives include: CONSTAB™ SL 0581 (slip), CONSTAB™ SL 05095 PPR (slip), CONSTAB™ SL 05077 PPR (slip), and CONSTAB™ SAT 04551 PP (antistat and slip).

Film 10 can also include processing aid additives. The processing aid additives can, for example, enhance flow characteristics of the film. In some embodiments, film 10 includes anti-fog additives. The anti-fog additives can, for example, migrate to the surface of the film to substantially prevent the formation of visible condensation on the film.

A large number of end-use applications for film 10 can be realized by tailoring the properties of film 10 with the above or additional additives during its manufacture. For example, film 10 can include certain desired functional, tactile, cosmetic, or other effects. For example, certain embodiments can have smooth surfaces or rough surfaces. In addition, the film can be soft or crinkly.

In addition, film 10 can be tailored to demonstrate certain visual aesthetics. For example, film 10 can be completely opaque, completely transparent, or any desired degree of transparency. Film 10 can be any desired color, such as for example, clear, white, blue, or black. Film 10 can have a glossy finish or a matte finish.

Film 10 can also be tailored to demonstrate enhanced resistance to environmental factors. For example, film 10 can be resistant to certain chemical solvents, such as certain bases or acids. Film 10 can be substantially resistant to ultraviolet (UV) light. Film 10 can provide good abrasion or scuff resistance. Film 10 can provide a protective barrier against moisture, vapors, and bacteria. Film 10 can provide substantial heat resistance.

Film 10 can demonstrate one or more material characteristics on one or more sides. For example, film 10 can have one or more anti-fogging, antistatic, and moisture resistance properties on one or more sides. Film 10 can be configured to allow for metallizing on one or more sides. Film 10 can be easy to coat, print and laminate one or more sides. Film 10 can be configured to be heat sealable on one or more sides.

Beyond adjusting the properties of polypropylene through additives, film 10 can also be specially treated to achieve desired effects. For example, one or more surface treatments can be applied to the film to impart a desired functional, tactile, cosmetic, or other effect to the surface. For example, in some embodiments, the surface treatment can promote adhesion of printing ink and/or paints.

In some embodiments, film 10 includes one or more coatings, such as for example silicone, adhesive, premask, or print treatments. The coatings can, for example, be used for purposes such as labeling, printing, physical protection, or other purposes. One or more sides of the film can be treated with corona or flame, which can improve ink adhesion and roll winding. In some cases, migratory additives within the film will migrate preferentially to a treated film surface. As a result, in some cases a non-treated surface of film 10 will experience diminished effects from additives embedded within the film. In some embodiment, the treatment is configured to optimize the blooming of the additive to the outside layers of film 10.

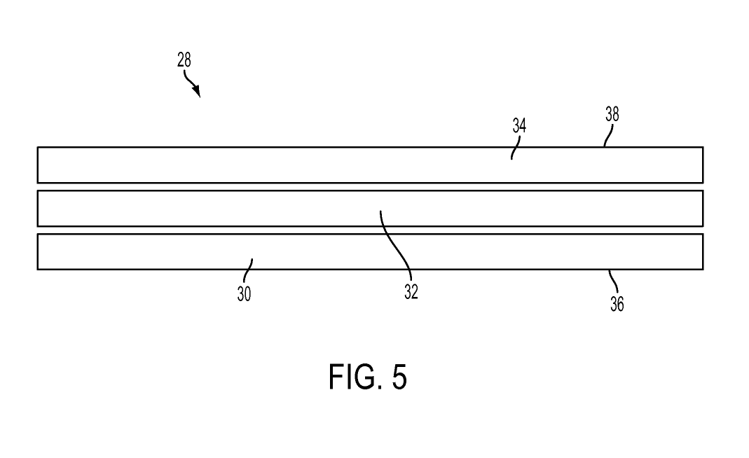

In some embodiments, such as the embodiments shown in FIG. 5-10 discussed below, film 10 is formed by combining several layers of films. For example, film 10 can be formed from 1 to 10 or more layers. Multi-layer film can be created, for example, by combining layers of film from separate rollers. In some embodiments, film 10 can be formed from five rollers vertically arranged to vertically stack the layers. For a film having five layers, the top two layers and bottom two layers can be combined first before all five layers are combined together.

An inside layer of film 10 (e.g., the layer on the inside of a bag formed by film 10) can be made of a softer, less stiff terpolymer resin. In some embodiments, an outside layer (that is, a layer on the outside of the bag) can be made of a high-crystallinity polypropylene, which can prevent the film from being scratched, marred or scuffed during bag making operations. In some embodiments, a layer of a softer polymer having a lower modulus, such as medium-density polyethylene (MDPE) can be coextruded with another layer of film 10. Such a softer inner layer can serve to substantially prevent scratching of the item by the film.

For multiple-layer films, additives can be blended into any of the layers. In some embodiments, a migratory slip additive is blended into a layer of the film that does not form one of the outer surfaces of film 10 (for example, a core or intermediate layer). The additive can then migrate to a surface of the film and create a thin layer that can act as a lubricant to prevent scratches. In some embodiments, certain migratory additives can be chosen to optimize the speed and stability of blooming while minimizing haze in the film. Film 10 can have a single set of properties or can have separate portions with one or more different sets of properties.

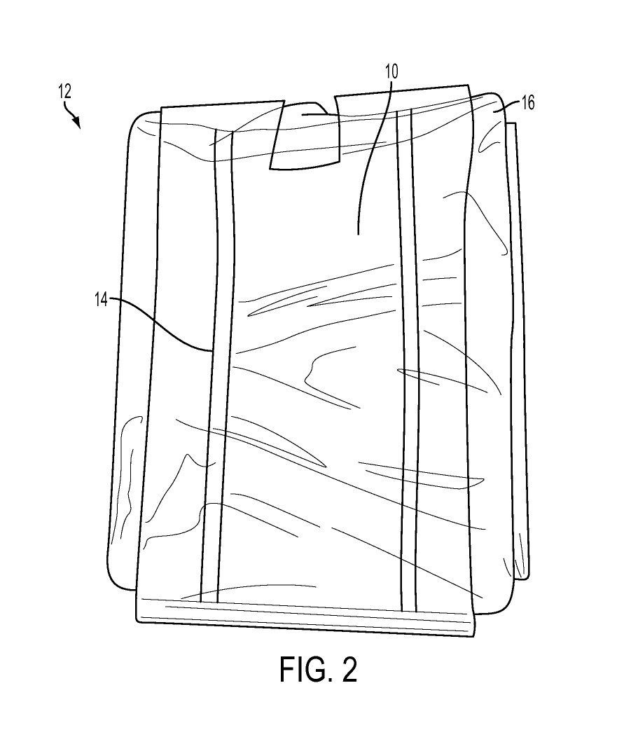

FIG. 2 illustrates bag 12 formed from a film in accordance with an embodiment of the present invention. For example, bag 12 can be formed from film 10. To form bag 12, film 10 can be folded over itself and affixed via a heat seal 14. One or more heat seals can be used to create bottom and side walls of bag 12. In some embodiments, one or more heat seals alone or in combination with other sealing devices can prevent fluid or pressure leakage from bag 12. In some embodiments, bag 12 is not configured to prevent fluid or pressure leakage from bag 12. An opening 16 can be formed at the top of bag 12 by the remaining unsealed sides. After an item is placed in hag 12, opening 16 can be securely closed via a heat seal, adhesive, or another suitable closure. In some embodiments, opening 16 is not configured to be closed by bag 12. In some embodiments, opening 16 is left open or closed by a separate top, such as a lid. Bag 12 can include one or more gussets or folds on the sides or bottom to enlarge the size of bag 12 when opened. Bag 12 can be larger or smaller than shown in FIG. 2, can be a different shape, including one or more flaps, and can have a different orientation and combination of one or more heat seals 14.

Bag 12 can be formed from a single piece of film 10 or multiple pieces of the same or different types of film. In embodiments where bag 12 is formed from a single piece of film 10, film 10 can have a single set of properties or can have separate portions with one or more different sets of properties. In embodiments where bag 12 is formed from multiple pieces of the same or different types of film 10, the multiple pieces of film 10 can have the same or different sets of properties. Bag 12 can be used by itself or within other packaging, such as a box or clamshell container, to provide additional protection of the item.

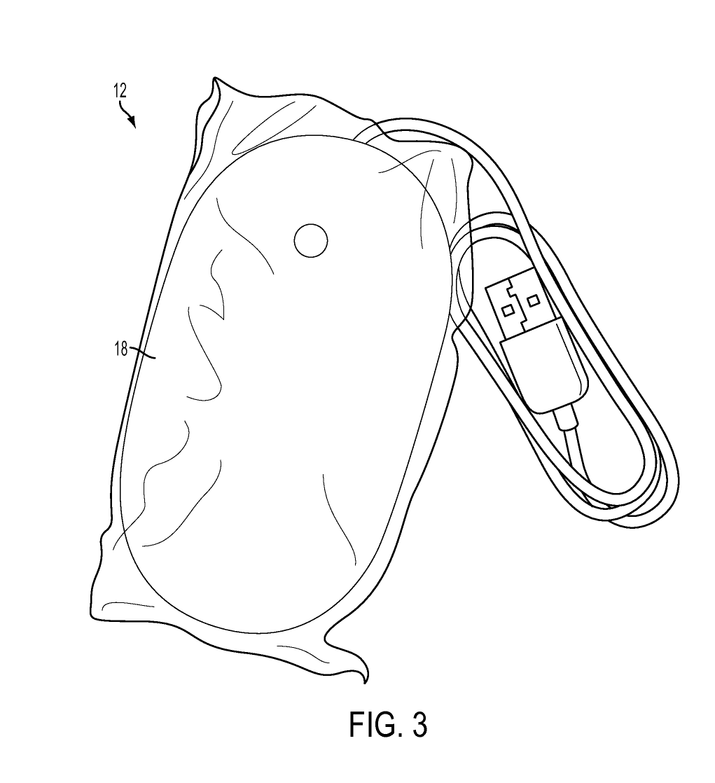

FIG. 3 illustrates bag 12 containing a computer mouse 18 in accordance with an embodiment of the present invention. In some embodiments, bag 12 can loosely fit over computer mouse 18. In some embodiments, bag 12 can be vacuum or thermo formed to mouse 18. In some embodiments, bag 12 can be adhesively or otherwise attached to mouse 18.

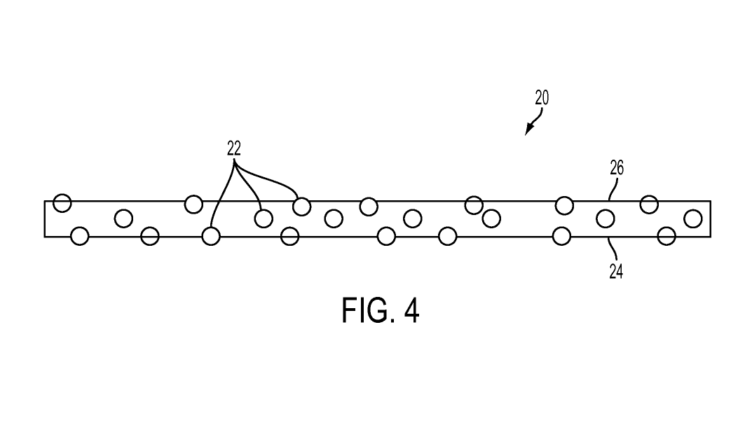

FIGS. 4-10 illustrate simplified cross-sections of single or multi-layer films according to embodiments of the present invention. For each of these simplified cross-sections, the thickness and size of the film and/or additives are not intended to be to scale. In addition, the density, distribution, and location of the additives within the film as well as the shape of additives are generalized for purposes of illustration.

FIG. 4 is a diagram of a simplified cross-section of a one-layer piece of film shown generally at 20. Film 20 is formed from a single layer of BOPP film including additives 22. Film 20 includes a first side 24 and a second side 26. Film 20 can be formed into bag 12 such that either first side 24 or second side 26 faces the inside of the bag. Film 20 can be made of any combination of the base films, additives, or surface treatments described herein.

Several examples of films are described below.

### Example 1

FIG. 5 is a diagram of a simplified cross-section of a three-layer piece of film shown generally at 28. In one embodiment, film 28 is formed from a first layer 30, a second layer 32, and a third layer 34 of film. Each layer of film is made of MOPLEN™ without any additives. Film 28 includes a first side 36 and a second side 38. Film 28 can be formed into bag 12 such that either first side 36 or second side 38 faces the inside of the bag.

The coefficient of friction between second side 38 of the film and second side 38 of another piece of the film is about 0.47 μs. The coefficient of friction between first side 36 of the film and second side 38 of another piece of the film is about 0.40 μs. The coefficient of friction between first side 36 of the film and first side 36 of another piece of the film is about −0.37 μs. The haze of the film ranges from about 0.83% to about 1.27%. Film 28 can be made of any combination of the base films or surface treatments described herein.

### Example 2

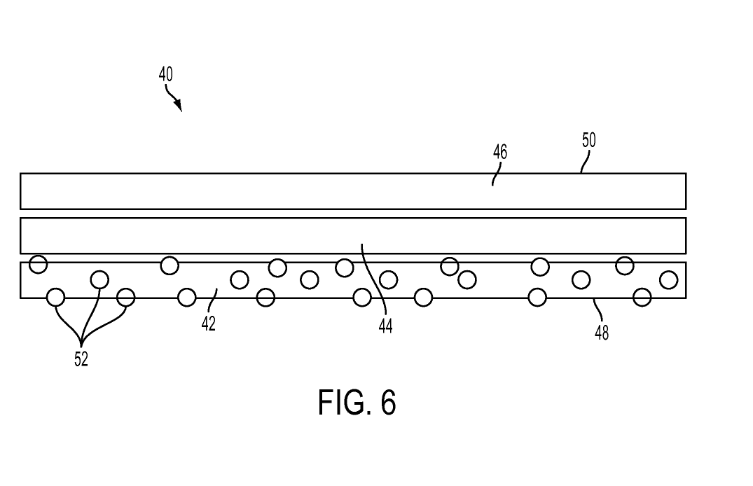

FIG. 6 is a diagram of a simplified cross-section of another three-layer piece of film shown generally at 40. In one embodiment, film 40 is formed from a first layer 42, a second layer 44, and a third layer 46 of film. First layer 42 is made from a master batch having about 95% MOPLEN™ and about 5% organic antiblock additive 52 (CONSTAB™ AB 06064 PPR). Second layer 44 and third layer 46 are made of MOPLEN™. Film 40 includes a first side 48 and a second side 50. Film 40 can be formed into bag 12 such that either first side 48 or second side 50 faces the inside of the bag.

The coefficient of friction between second side 50 of the film and second side 50 of another piece of the film is about 0.45 μs. The coefficient of friction between first side 48 of the film and second side 50 of another piece of the film is about 0.32 μs. The coefficient of friction between first side 48 of the film and first side 48 of another piece of the film is about 0.23 μs. The haze of the film ranges from about 1.52% to about 1.92%.

### Example 3

In another embodiment, first layer 42 is made from a master batch having about 95% MOPLEN™ and about 5% organic antiblock and slip additive 52 (CONSTAB™ SAB 06564). Second layer 44 and third layer 46 are made of MOPLEN™.

Additive 52 is a spherical size of about 3.5 micron particles with very narrow particle size distribution. The particle size for additive 52 can range from about 4 to about 4.5 microns, compared with about 8 to about 9 micron silica particles that can be found in a master batch of about 4 micron silica. Additive 52 is thermally stable up to about 850° C. The slip additive is Ultra High Molecular Weight (about 25 million centi-Stokes) silicon.

The coefficient of friction between second side 50 of the film and second side 50 of another piece of the film is about 0.38 μs. The coefficient of friction between first side 48 of the film and second side 50 of another piece of the film is about 0.28 μs. The coefficient of friction between first side 48 of the film and first side 48 of another piece of the film is about 0.18 μs. The haze of the film ranges from about 1.34% to about 1.62%.

### Example 4

In another embodiment, first layer 42 is made from a master batch having about 95% MOPLEN™ and about 5% slip additive 52 (Behenamide or CONSTAB™ SL 0581). Second layer 44 and third layer 46 are made of MOPLEN™.

The coefficient of friction between second side 50 of the film and second side 50 of another piece of the film is about 0.46 μs. The coefficient of friction between first side 48 of the film and second side 50 of another piece of the film is about 0.40 μs. The coefficient of friction between first side 48 of the film and first side 48 of another piece of the film is about 0.30 μs. The haze of the film ranges from about 1.09% to about 1.92%.

### Example 5

In another embodiment, first layer 42 is made from a master batch having about 90% MOPLEN™, about 5% slip additive (Behenamide or CONSTAB™ SL 0581), and about 5% organic antiblock additive CONSTAB™ AB 06064 PPR. The slip additive and antiblock additive are combined in the figure as additive 52. Second layer 44 and third layer 46 are made of MOPLEN™.

The coefficient of friction between second side 50 of the film and second side 50 of another piece of the film is about 0.42 μs. The coefficient of friction between first side 48 of the film and second side 50 of another piece of the film is about 0.32 μs. The coefficient of friction between first side 48 of the film and first side 48 of another piece of the film is about 0.24 μs. The haze of the film ranges from about 1.50% to about 1.84%.

### Example 6

In another embodiment, first layer 42 is made from a master batch having about 97.5% MOPLEN™ and about 2.5% slip additive 52 (silicone oil, CONSTAB™ SL 05095 PPR). Second layer 44 and third layer 46 are made of MOPLEN™.

The coefficient of friction between second side 50 of the film and second side 50 of another piece of the film is about 0.48 μs. The coefficient of friction between first side 48 of the film and second side 50 of another piece of the film is about 0.40 μs. The coefficient of friction between first side 48 of the film and first side 48 of another piece of the film is about 0.32 μs. The haze of the film ranges from about 0.71% to about 1.30%.

### Example 7

In another embodiment, first layer 42 is made from a master batch having about 92.5% MOPLEN™, about 2.5% slip additive (silicone oil, CONSTAB™ SL 05095 PPR), and about 5% organic antiblock (CONSTAB™ AB 06064 PPR). The slip additive and antiblock additive are combined in the figure as additive 52. Second layer 44 and third layer 46 are made of MOPLEN™.

The coefficient of friction between second side 50 of the film and second side 50 of another piece of the film is about 0.49 μs. The coefficient of friction between first side 48 of the film and second side 50 of another piece of the film is about 0.30 μs. The coefficient of friction between first side 48 of the film and first side 48 of another piece of the film is about 0.18 μs. The haze of the film ranges from about 1.34% to about 1.81%.

### Example 8

In another embodiment, first layer 42 is made from a master batch having about 95% MOPLEN™ and about 5% silicone gum additive 52 (CONSTAB™ SL 05077 PPR). Second layer 44 and third layer 46 are made of MOPLEN™.

The coefficient of friction between second side 50 of the film and second side 50 of another piece of the film is about 0.54 μs. The coefficient of friction between first side 48 of the film and second side 50 of another piece of the film is about 0.38 μs. The coefficient of friction between first side 48 of the film and first side 48 of another piece of the film is about 0.27 μs. The haze of the film ranges from about 0.63% to about 1.57%.

### Example 9

In another embodiment, first layer 42 is made from a master batch having about 90% MOPLEN™, about 5% silicone gum additive (CONSTAB™ SL 05077 PPR), and about 5% additive 52 (organic antiblock CONSTAB™ AB 06064 PPR). Second layer 44 and third layer 46 are made of MOPLEN™.

The coefficient of friction between second side 50 of the film and second side 50 of another piece of the film is about 0.49 μs. The coefficient of friction between first side 48 of the film and second side 50 of another piece of the film is about 0.30 μs. The coefficient of friction between first side 48 of the film and first side 48 of another piece of the film is about 0.20 μs. The haze of the film ranges from about 1.31% to about 2.32%.

### Example 10

In another embodiment, first layer 42 and second layer 44 are made of MOPLEN™ Third layer 46 is made of DOWLEX™ SC 2108G Polyethylene Resin. This resin was selected due to its processability on BOPP manufacturing equipment. For example, alternative polyethylene resins can be difficult to stretch and transport on heated rolls as the layer softens and sticks to heated rolls.

For a first batch of this film, the coefficient of friction between second side 50 of the film and second side 50 of another piece of the film is about 0.37 μs. The coefficient of friction between first side 48 of the film and second side 50 of another piece of the film is about 0.23 μs. The coefficient of friction between first side 48 of the film and first side 48 of another piece of the film is about 0.40 μs. The haze of the film ranges from about 1.11% to about 2.59%.

For a second batch of this film, the coefficient of friction between second side 50 of the film and second side 50 of another piece of the film is about 0.42 μs. The coefficient of friction between first side 48 of the film and second side 50 of another piece of the film is about 0.27 μs. The coefficient of friction between first side 48 of the film and first side 48 of another piece of the film is about 0.41 μs. The haze of the film ranges from about 1.18% to about 1.43%.

### Example 11

In another embodiment, first layer 42 is made from a master batch having about 95% MOPLEN™ and about 5% additive 52 (organic antiblock CONSTAB™ AB 06064 PPR). Second layer 44 is made of MOPLEN™. Third layer 46 is made of DOWLEX™ SC 2108G Polyethylene Resin.

The coefficient of friction between second side 50 of the film and second side 50 of another piece of the film is about 0.41 μs. The coefficient of friction between first side 48 of the film and second side 50 of another piece of the film is about 0.31 μs. The coefficient of friction between first side 48 of the film and first side 48 of another piece of the film is about 0.22 μs. The haze of the film ranges from about 1.90% to about 2.25%.

### Example 12

In another embodiment, first layer 42 is made from a master batch having about 95% MOPLEN™ and about 5% organic antiblock and slip additive 52 (CONSTAB™ SAB 06564). Second layer 44 is made of MOPLEN™. Third layer 46 is made of DOWLEX™ SC 2108G Polyethylene Resin.

The coefficient of friction between second side 50 of the film and second side 50 of another piece of the film is about 0.38 μs. The coefficient of friction between first side 48 of the film and second side 50 of another piece of the film is about 0.29 μs. The coefficient of friction between first side 48 of the film and first side 48 of another piece of the film is about 0.20 μs. The haze of the film ranges from about 2.91% to about 3.26%.

### Example 13

In another embodiment, first layer 42 is made from a master batch having about 95% MOPLEN™ and about 5% silicone gum additive 52 (CONSTAB™ SL 05077 PPR). Second layer 44 is made of MOPLEN™. Third layer 46 is made of DOWLEX™ SC 2108G Polyethylene Resin.

The coefficient of friction between second side 50 of the film and second side 50 of another piece of the film is about 0.37 μs. The coefficient of friction between first side 48 of the film and second side 50 of another piece of the film is about 0.21 μs. The coefficient of friction between first side 48 of the film and first side 48 of another piece of the film is about 0.24 μs. The haze of the film ranges from about 2.06% to about 3.18%.

### Example 14

In another embodiment, first layer 42 is made from a master batch having about 90% MOPLEN™, about 5% silicone gum additive (CONSTAB™ SL 05077 PPR), and 5% additive (organic antiblock CONSTAB™ AB 06064 PPR). The slip additive and antiblock additive are combined in the figure as additive 52. Second layer 44 is made of MOPLEN™. Third layer 46 is made of DOWLEX™ SC 2108G Polyethylene Resin.

The coefficient of friction between second side 50 of the film and second side 50 of another piece of the film is about 0.46 μs. The coefficient of friction between first side 48 of the film and second side 50 of another piece of the film is about 0.30 μs. The coefficient of friction between first side 48 of the film and first side 48 of another piece of the film is about 0.19 μs. The haze of the film ranges from about 2.00% to about 2.79%.

### Example 15

In another embodiment, first layer 42 is made from a master batch having about 95% MOPLEN™ and about 5% additive 52 (Shantou Best Polybatch ABPP905A). Second layer 44 is made of MOPLEN™. Third layer 46 is made of NAN YA 2020S. One or both first side 48 and second side 50 are treated with corona or flame, which improves ink adhesion and roll winding.

The coefficient of friction between second side 50 of the film and second side 50 of another piece of the film is about 0.83 μs. The coefficient of friction between first side 48 of the film and second side 50 of another piece of the film is about 0.35 μs. The coefficient of friction between first side 48 of the film and first side 48 of another piece of the film is about 0.33 μs. The haze of the film ranges from about 1.50% to about 1.65%.

### Example 16

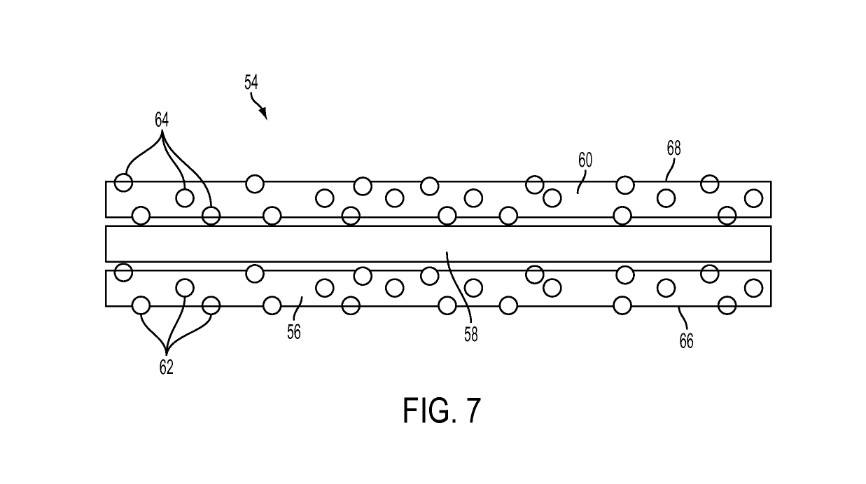

FIG. 7 is a diagram of a simplified cross-section of another three-layer piece of film shown generally at 54. In one embodiment, film 54 is formed from a first layer 56, a second layer 58, and a third layer 60 of film. First layer 56 is made from a master batch having about 95% MOPLEN™ and about 5% additive 62 (Shantou Best Polybatch ABPP905A). Second layer 58 is made of MOPLEN™. Third layer 60 is made of a master batch having about 95% NAN YA 2020S and 5% additive 64 Shantou Best Polybatch ABPP905A. Film 54 includes a first side 66 and a second side 68. Film 54 can be formed into bag 12 such that either first side 66 or second side 68 faces the inside of the bag.

The coefficient of friction between second side 68 of the film and second side 68 of another piece of the film is about 0.33 μs. The coefficient of friction between first side 66 of the film and second side 68 of another piece of the film is about 0.33 μs. The coefficient of friction between first side 66 of the film and first side 66 of another piece of the film is about 0.33 μs. The haze of the film ranges from about 2.12% to about 2.28%.

### Example 17

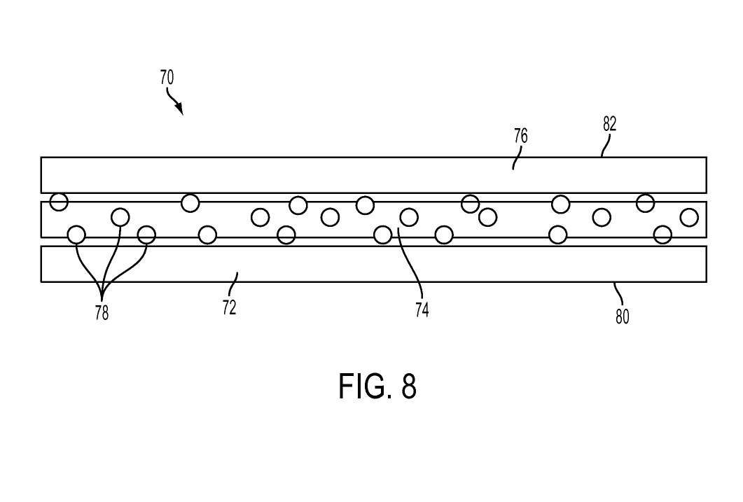

FIG. 8 is a diagram of a simplified cross-section of another three-layer piece of film 70. In one embodiment, film 70 is formed from a first layer 72, a second layer 74, and a third layer 76 of film. First layer 72 is made of MOPLEN™. Second layer 74 is made from a master batch having about 97% MOPLEN™ and about 3% migratory antistatic and slip additive 78 (CONSTAB™ SAT 04551 PP). Third layer 76 is made of MOPLEN™. Film 70 includes a first side 80 and a second side 82. Film 70 can be formed into bag 12 such that either first side 80 or second side 82 faces the inside of the bag.

The particular grade of additive 78 was chosen because it migrates fast and remains stable on the surface of the film. The grade was also chosen because unlike other slip additives, it does not cause hazy build up on the film surface with increased storage time. The master batch was incorporated into an inner layer, but has the ability to migrate to an outer layer of the film.

The coefficient of friction between second side 82 of the film and second side 82 of another piece of the film is about 0.44 μs. The coefficient of friction between first side 80 of the film and second side 82 of another piece of the film is about 0.39 μs. The coefficient of friction between first side 80 of the film and first side 80 of another piece of the film is about 0.38 μs. The haze of the film ranges from about 0.83% to about 1.26%.

### Other Examples

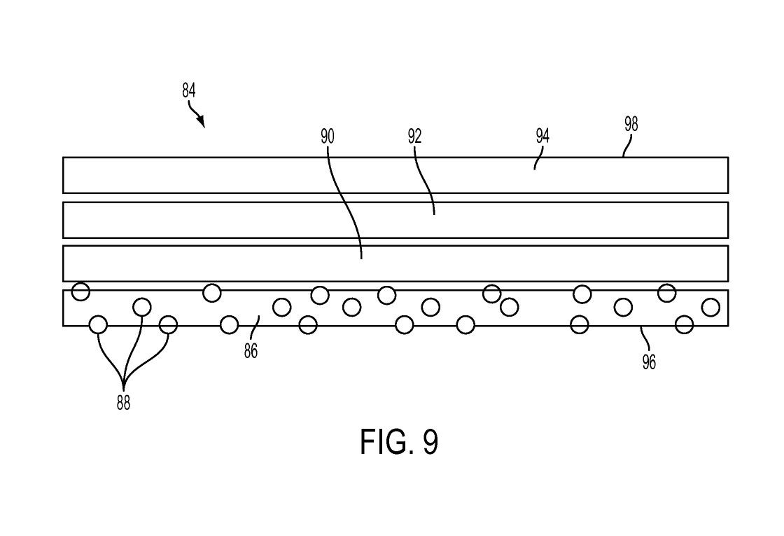

FIG. 9 is a diagram of a simplified cross-section of a four-layer piece of film shown generally at 84. In one embodiment, film 84 is formed from a first layer 86, a second layer 90, a third layer 92, and a fourth layer 94 of film. First layer 86 includes additives 88. Film 84 includes a first side 96 and a second side 98. Film 84 can be formed into bag 12 such that either first side 96 or second side 98 faces the inside of the bag. Film 84 can include any of the films or additives described herein. Film 84 can be made of any combination of the base films, additives, or surface treatments described herein.

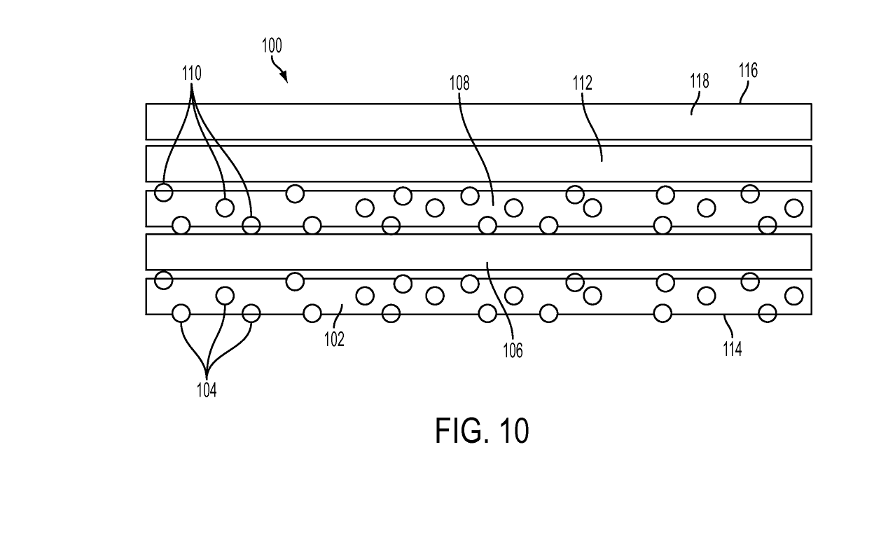

FIG. 10 is a diagram of a simplified cross-section of a five-layer piece of film shown generally at 100. In one embodiment, film 100 is formed from a first layer 102, a second layer 106, a third layer 108, a fourth layer 112, and a fifth layer 118 of film. First layer 102 and third layer 108 include additives 104 and 110 respectively. Film 100 includes a first side 114 and a second side 116. Film 100 can be formed into bag 12 such that either first side 114 or second side 116 faces the inside of the bag. Film 100 can be made of any combination of the base films, additives, or surface treatments described herein.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance. For example, films can be made of any combination of the base films, additives, or surface treatments described herein.

In addition, the breadth and scope of the present invention should not be limited by any of the above-described exemplary embodiments, but should be defined only in accordance with the following claims and their equivalents.

1. A bi-axially oriented coextruded multilayer film comprising:
a first layer of film made of a polypropylene homopolymer;
a second layer of film formed to the first layer of film, wherein the film is made from a mixture of a polypropylene homopolymer and a migratory antistatic and slip additive; and
a third layer of film formed to the second layer of film, wherein the third layer of film is made of a polypropylene homopolymer.

2. The multilayer film of claim 1, wherein the second layer of film is made from a mixture of about 97% of a polypropylene homopolymer without film additives and about 3% of a migratory antistatic and slip additive.

3. The multilayer film of claim 1, wherein the one or more film additives include the migratory antistatic and slip additive CONSTAB™ SAT 04551 PP.

4. The multilayer film of claim 1, wherein the first layer of film and the second layer of film do not contain film additives.

5. The multilayer film of claim 1, wherein the polypropylene homopolymers of the first, second, and third layers of film have a tensile modulus of about 1700-2000 MPa in a machine direction and about 2800-3800 MPa in a transverse direction.

6. The multilayer film of claim 1, wherein the polypropylene homopolymers of the first, second, and third layers of film are the same.

7. The multilayer film of claim 1, wherein the polypropylene homopolymers of the first and third layers of film are MOPLEN™ HP522H film.

8. The multilayer film of claim 1,
wherein the migratory film additive blooms to the surface of the film to create a lubricating layer between the surface of the film and a polycarbonate surface of an item in contact with the film to lower a blocking tendency between multiple pieces of multilayer film, and
wherein the migratory antistatic and slip additive will not scratch the polycarbonate surface during normal distribution and handling.

9. The multilayer film of claim 1, further comprising a fourth layer of film.

10. The multilayer film of claim 1, wherein the multilayer film is coated with a layer of silicone oil.

11. The multilayer film of claim 1, wherein the multilayer film is subjected to a corona treatment.

12. The multilayer film of claim 1, wherein the first layer of film is made from a mixture of polypropylene homopolymer and film additives.

13. A bi-axially oriented coextruded multilayer film comprising:
a first layer of film made entirely of a semi-crystalline polypropylene homopolymer without film additives, wherein the polypropylene homopolymer has a tensile modulus of about 1700-2000 MPa in a machine direction and about 2800-3800 MPa in a transverse direction and a melt flow rate of approximately 2.0 g/10 min (230° C./2.16 Kg);
a second layer of film formed to the first layer of film, wherein the film is made from a mixture of about 97% of the polypropylene homopolymer without film additives, and about 3% of a migratory antistatic and slip additive; and
a third layer of film formed to the second layer of film, wherein the third layer of film is made entirely of the polypropylene homopolymer.

14. The multilayer film of claim 13, wherein the multilayer film is subjected to a corona treatment.

15. The multilayer film of claim 13, wherein the migratory antistatic and slip additive blooms to the surface of the film to create a lubricating layer between the surface of the film and a polycarbonate surface of an item in contact with the film to lower a blocking tendency between multiple pieces of multilayer film, and
wherein the migratory antistatic and slip additive will not scratch the polycarbonate surface during normal distribution and handling.

16. Packaging formed by one or more pieces of biaxially oriented coextruded multilayer film, the multilayer film comprising:
a first layer of film made of a polypropylene homopolymer;
a second layer of film formed to the first layer of film, wherein the film is made from a mixture of about 97% of the polypropylene homopolymer without film additives, and about 3% of a film additive; and
a third layer of film formed to the second layer of film, wherein the third layer of film is made of a polypropylene homopolymer.

17. The packaging of claim 16, wherein the multilayer film will not scratch a polycarbonate surface in contact with the film during normal distribution and handling of the packaging.

18. The packaging of claim 16, wherein the packaging is a heat-sealed bag.

19. The packaging of claim 18, wherein a single piece of the multilayer film forms the bag.

20. The packaging of claim 18, wherein a single piece of the multilayer film is heat-sealed to itself to form the bag.

21. The packaging of claim 18, wherein multiple pieces of the multilayer film form the bag.

22. A biaxially oriented film comprising:
a layer of film made from a mixture of polypropylene homopolymer and a migratory film additive,
wherein the migratory film additive blooms to the surface of the film to create a lubricating layer between the surface of the film and a polycarbonate surface of an item in contact with the film,
wherein the migratory film additive lowers a blocking tendency between multiple multilayer films, and
wherein the migratory film additive will not scratch the polycarbonate surface during normal distribution and handling.

23. The film of claim 22, wherein the film is adhered on a first side to a layer of film made from a polypropylene homopolymer without additives.

24. The film of claim 23, wherein the film is adhered on a second side to another layer of film made from a polypropylene homopolymer without additives.

25. The film of claim 22, wherein the migratory additive is an antistatic and slip additive.
